(19) United States
(12) Patent Application Publication
(10) Pub. No.: US 2004/0059081 A1
(43) Pub. Date: Mar. 25, 2004

(54) Process for preparing polyaddition compounds containing uretdione groups

(75) Inventors: Andreas Wenning, Nottuln (DE); Thomas Weihrauch, Duelmen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DE GUSSA AG, Duesseldorf (DE)

(21) Appl. No.: 10/461,869

(22) Filed: Jun. 16, 2003

Related U.S. Application Data
(63) Continuation of application No. 10/082,194, filed on Feb. 26, 2002, now abandoned.

(30) Foreign Application Priority Data
Apr. 14, 2001 (DE) 101 18 540.5

(51) Int. Cl. C08G 18/10; C08G 18/32; C08G 18/38; C08G 18/60

(52) U.S. Cl. 528/65

(57) ABSTRACT

A polyaddition compound containing an uretdione group is obtained by solvent-free preparation in an intensive mixer, especially in a single-screw or multiscrew extruder.

### BACKGROUND OF THE INVENTION

1. Field of the Invention

The invention relates to a novel process for the solvent-free preparation of a polyaddition compound containing an uretdione group.

2. Discussion of the Background

Polyaddition compounds containing uretdione groups are presently used as crosslinkers in light- and weatherstable polyurethane (PU) powder coating materials. During the thermal cure, the uretdione groups of these polyaddition compounds cleave into free isocyanate groups, which subsequently crosslink with hydroxyfunctional resins to form powder coating films.

The principle of preparing polyaddition compounds containing uretdione groups is known. Customarily, these compounds are prepared in the presence of appropriate solvents. The reason is the prevention of the thermal cleaving of the uretdione rings during the synthesis of the polyaddition compounds. Since the uretdione ring cleaves in the presence of hydroxyfunctional reactants at temperatures as low as about 110° C., the polyaddition compounds are produced under mild conditions at about 60° C. The preparation of polyaddition compounds containing uretdione groups in solvent has not only the disadvantage that the solvent or solvent mixture must be removed again afterwards. There is also a need for long reaction times and complex, specialty technologies for solvent removal.

Thin-film evaporators or film extruders are suitable for freeing the reaction products from the solvent under reduced pressure at about 120° C. These processes are, however, very costly.

Polyaddition compounds containing uretdione groups may be prepared continuously in an intensive mixer such as a twin-screw extruder with far less complexity and much more simplicity. The principle of this process is that the reaction products are heated briefly to high temperatures which are unusual for polyisocyanates containing uretdione groups but necessary for the solvent-free preparation. This brief thermal loading is sufficient to bring about homogeneous mixing of the reactants and to react them. Despite the temperatures in the range of 120-190° C., the uretdione groups in this case do not cleave back into free isocyanate groups. With this process, products of consistently high quality are obtained.

A solvent-free process of this kind is known for some powder coating crosslinkers containing uretdione groups. For instance, EP 669 353 describes the preparation of hydroxyl-terminal polyaddition compounds containing uretdione groups. Co-reactants for the uretdione used, which is the uretdione of 3-isocyanatomethyl-3,5,5-trimethylcyclohexyl isocyanate (or isophorone diisocyanate, or IPDI for short) are linear diols and/or linear polyesterpolyols. These polyaddition compounds are therefore linear in structure.

EP 780 417 and EP 825 214 describe the preparation of hydroxyl-containing polyaddition compounds, containing uretdione groups, from uretdiones, polyols, and chain extenders such as polyesterpolyols or polycaprolactones. These compounds with terminal hydroxyl groups possess a functionality of more than two.

According to EP 669 354, this process may also be used to react a polyisocyanate uretdione with diols and, as the case may be, with monoalcohols or monoamines in a solvent-free, continuous reaction in an intensive kneading apparatus. These products possess terminally either NCO groups or NCO/OH groups or do not carry any end-group functionality.

Uretdione powder coating crosslinkers which are prepared by reacting polyisocyanates, containing uretdione groups, with diols and chain extenders containing ester and/or carbonate groups, and/or using dimer diols, are described in EP 639 598 and in EP 720 994. These products are prepared solventlessly but batchwise. Relatively small batches—up to a few hundred kilograms—of these low-viscosity compounds, containing uretdione groups, can readily be prepared by this process. For the production of industrial quantities, relatively long times are required for discharge of the product melt from the reactor. As a result, a proportion of the uretdione rings are cleaved. Consequently, fluctuating qualities of product are produced. EP 1 063 251 describes an improved process for preparing such products. For this process, the polyaddition compounds containing uretdione groups are prepared in the melt in static mixers. The advantage lies in the lower residence time of the products in the vessel compared to the solvent-free process. To mix viscous compounds, a static mixer must be of a relatively long design. Consequently, despite their relatively low viscosity, the polyaddition compounds containing uretdione groups reside in the static mixer for a relatively long time. The result is that, once again, a considerable amount of uretdione cleavage occurs.

### SUMMARY OF THE INVENTION

It is an object of the present invention, to provide a novel process for preparing a polyaddition product containing an uretdione group from a polyisocyanate containing an uretdione group and a hydroxyl-containing polymer and a further component wherein the novel process does not have the abovementioned disadvantages of known processes.

This object has been achieved by the present invention the first embodiment of which includes a process for solventlessly and continuously preparing a polyaddition compound containing an uretdione group, comprising:

reacting in an intensive mixer

A) at least one polyisocyanate containing an uretdione group and having an isocyanate functionality of at least 2.0, and

B) at least one hydroxyl-containing polymer containing at least two hydroxyl groups and at least one further functional group selected from the group consisting of a carboxyl ester group, a carbonate group, an ether group, a thioether group, an ester amide group, an urethane group, an acetal group and a combination thereof;

wherein said hydroxyl-containing polymer has a molecular weight of from 180 to 3500;

wherein said polyaddition compound containing an uretdione group has a melting range of from 40 to 130° C. and contains a) free, partially or totally blocked NCO groups or b) free, partially or totally blocked NCO groups and a terminal hydroxyl group.

### DETAILED DESCRIPTION OF THE INVENTION

It has surprisingly been found that a polyaddition compound containing an uretdione group can be prepared in an intensive mixer without any re-cleavage of the uretdione group. In order to obtain complete reaction of the starting materials, the compounds must be heated at temperatures of 110-190° C. The temperature includes all values and subvalues therebetween, especially including 120, 130, 140, 150, 160, 170 and 180° C. Since, these compounds have a lower melt viscosity than the products from EP 669 353, EP 780 417, and EP 825 214, it was to have been expected that the uretdione ring would cleave into the free isocyanate at relatively low temperatures. It was surprising that, despite the high temperatures in the intensive mixer, which is clearly operated above the decomposition temperature of uretdiones, the compounds exhibit no re-cleavage as in the case of preparation in a vessel or in a static mixer. The advantage of the process of the invention is that the short residence times in an intensive mixer allow products of outstanding quality to be obtained.

The present invention accordingly provides a process for solventlessly and continuously preparing a polyaddition compound containing an uretdione group, with a melting range of from 40 to 130° C., the polyaddition compound containing a) free, partially or totally blocked NCO groups or b) free, partially or totally blocked NCO groups and a terminal hydroxyl group, in an intensive mixer by reaction of

A) at least one polyisocyanate containing an uretdione group and having an isocyanate functionality of at least 2.0,

B) at least one hydroxyl-containing polymer containing at least two hydroxyl groups and at least one further functional group selected from the group consisting of a carboxyl ester group, a carbonate group, an ether group, a thioether group, an ester amide group, an urethane and an acetal group and having a molecular weight of from 180 to 3500,

C) optionally, at least one diol having a molecular weight of from 62 to 400, and

D) optionally, at least one monofunctional compound which is reactive toward an isocyanate group.

The melting temperature of the polyaddition compound is preferably 40 to 130° C. The melting temperature includes all values and subvalues therebetween, especially including 50, 60, 70, 80, 90, 100, 110 and 120° C.

The molecular weight of the hydroxyl-containing polymer in compound B) is preferably 180 to 3500. This molecular weight includes all values and subvalues therebetween, especially including 200, 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300 and 3400.

The molecular weight of the diol is preferably 62 to 400. This molecular weight includes all values and subvalues therebetween, especially including 65, 70, 75, 80, 85, 90, 95, 100, 150, 200, 250, 300 and 350.

The polyisocyanate A) containing an uretdione group and having an average isocyanate functionality of at least 2.0, is obtained in a conventional manner from any desired diisocyanate by catalytic dimerization of some of the isocyanate groups of simple diisocyanates and preferably subsequent separation of the unreacted diisocyanate excess, for example by thin-film distillation. Preffered diisocyanates for preparing the polyisocyanate A) are aliphatic, cycloaliphatic, araliphatic and/or aromatic diisocyanates. Particularly preferred examples are 1,4 diisocyanatobutane, 1,6-diisocyanatohexane (HDI), 2-methylpentamethylene 1,5-diisocyanate (MPDI), 2,2,4(2,4,4)-trimethylhexamethylene diisocyanate (TMDI), 4,4′-diisocyanatodicyclohexylmethane (HMDI), 1,3- and 1,4-diisocyanatocyclohexane, isophorone diisocyanate (IPDI), norbornane diisocyanate, diphenylmethane 2,4′- and/or 4,4′-diisocyanate, xylylene diisocyanate or 2,4- and 2,6-tolylene diisocyanate, and any desired mixtures of these isomers. It is possible to use these diisocyanates alone or in mixtures in order to prepare the polyisocyanate A). The polyisocyanate containing an uretdione group, may be mixed with one another as desired.

Preferred catalysts for preparing the polyisocyanate A) from said diisocyanates are compounds which catalyze the dimerization of isocyanate groups. Particularly preferred examples are tertiary organic phosphines (U.S. Pat. No. 4,614,785, DE-As 1 934 763, 3 900 053), tris(dialkylamino)phosphines (DE-As 3 030 513, 3 227 779, 3 437 635), substituted pyridines (DE-As 1 081 895, 3 739 549), and substituted imidazoles or benzimidazoles (EP 417 603).

Preferred polyisocyanates A) for the process of the present invention are polyisocyanates containing uretdione groups that have been prepared from diisocyanates containing isocyanate groups attached to aliphatic and/or cycloaliphatic moieties.

Particular preference is given to using the uretdiones of isophorone diisocyanate (IPDI), of 2-methylpentamethylene 1,5-diisocyanate (MPDI), of 2,2,4(2,4,4)trimethylhexamethylene diisocyanate (TMDI), and of 1,6-diisocyanatohexane (HDI).

The use of isophorone diisocyanate allows an isocyanurate-free uretdione to be prepared. This uretdione is highly viscous at room temperature and has a viscosity of more than 10⁶ mPa·s; at 60° C. the viscosity is 13-10³ mPa·s and at 80° C. it is 1.4-10³ mpa·s. The free NCO content lies between 16.8 and 18.5% by weight, i.e., more or less high fractions of polyuretdione of IPDI must be present in the reaction product. The free NCO content includes all values and subvalues therebetween, especially including 16.9, 17.0, 17.1, 17.2, 17.3, 17.4, 17.5, 17.6, 17.7, 17.8, 17.9, 18.0, 18.1, 18.2, 18.3 and 18.4%. The monomer content is 1% by weight. The total NCO content of the reaction product after heating at 180-200° C. is 37.5-37.8% by weight.

During the dimerization of other aliphatic diisocyanates with conventional processes and catalysts, byproduct isocyanurate is formed in varying amounts, so that the NCO functionality of the isocyanurate-containing polyisocyanate uretdiones used is between 2 and 2.6. The NCO functionality includes all values and subvalues therebetween, especially including 2.1, 2.2, 2.3, 2.4 and 2.5.

Preferred hydroxyl-containing polymers B) for the process of the invention are those containing further a functional group. Such polymers are linear or branched, hydroxyl-containing polyesters, polycaprolactones, polycarbonates, polyethers, polythioethers, polyesteramides, polyurethanes or polyacetals. They possess a number-average molecular weight of from 180 to 3500, a hydroxyl number of between 50 and 900 mg KOH/g, and a functionality of from 2 to 5. The hydroxyl numbers includes all values and subvalues therebetween, especially including 100, 150, 200, 250, 300, 350, 400, 450, 500, 550, 500, 650, 700, 750, 800 and 850 mg KOH/g. The functionality includes all values and subvalues therebetween, especially including 2.5, 3, 3.5, 4 and 4.5.

Preferred polymers B) are polymers containing at least one ester group, carbonate group or ether group, of a molecular weight range of from 180 to 3500, in particular from 250 to 2000, especially from 300 to 1500. Mixtures of such polymers may likewise be used.

The polyesters are prepared, for example, by reacting diols or polyols without further functional groups with substoichiometric amounts of dicarboxylic acids or polycarboxylic acids, corresponding carboxylic anhydrides, corresponding carboxylic esters of lower alcohols, lactones or hydroxy carboxylic acids.

The polyesters B) are prepared using suitable polyols and aliphatic, cycloaliphatic, aromatic and/or heteroaromatic polycarboxylic acids. Preferred are succinic, adipic, suberic, azelaic, and sebacic acid, 2,2,4(2,4,4)-trimethyladipic acid, butanetetracarboxylic acid, ethylenetetraacetic acid, phthalic acid, isophthalic acid, dimethyl terephthalate, bisglycol terephthalate, maleic acid, maleic anhydride, and dimeric or trimeric fatty acids. Also included are hydroxy carboxylic acids such as hydroxycaproic acid. The polyester polyols may also be prepared using any desired mixtures of these exemplified starting compounds.

It is preferred to use aliphatic, optionally alkylbranched, polycarboxylic acids. However, lactones may also be reacted with polyols to give polyester polyols. Preferred lactones are, for example, β-propiolactone, γ-butyrolactone, γ- and δ-valerolactone, ε-caprolactone, 3,5,5- and 3,3,5-trimethylcaprolactone, or any desired mixtures of such lactones.

Polymers B) containing carbonate groups may be prepared, for example, by reacting polyols with diaryl carbonates, such as diphenyl carbonate, or phosgene.

Polyether polyols are obtainable by reacting polyhydric alcohols with alkylene oxides, such as ethylene oxide or propylene oxide.

Examples of preferred polyols for preparing the hydroxyl-containing polymers are the diols C) and also glycerol, trimethylolpropane, ditrimethylolpropane, trimethylolethane, 1,2,6-hexanetriol, 1,2,4-butane triol, 1,3,5-tris(2-hydroxyethyl) isocyanurate, pentaerythritol, mannitol or sorbitol.

Preferred diols C) for preparing the polyaddition compounds containing uretdione groups are all diols commonly used in PU chemistry with molecular weights from at least 62 to 400. Preferred examples include ethylene glycol, diethylene glycol, triethylene glycol, propylene glycol such as 1,2- and 1,3-propanediol, 2-methyl-1,3-propanediol, 2,2-dimethyl-1,3-propanediol (neopentyl glycol), 1,4-butanediol, 1,5-pentanediol, 3-methyl-1,5-pentanediol, 1,6-hexanediol, 2,2,4(2,4,4)trimethylhexanediol, 1,8-octanediol, 1,12-dodecanediol, trans- and cis-1,4-cyclohexanedimethanol, dimer diols, obtainable by hydrogenating dimeric fatty acids and/or their esters in accordance, for example, with DE 17 68 313 or EP 0 720 994, or neopentyl glycol hydroxypivalate.

The ratio in which components B) and C) are mixed is freely selectable. Preferably, they are used in a weight ratio of from 5:95 to 90:10.

In the process of the invention, it is also possible, where appropriate, to use a further compound, D), which is monofunctional and reactive toward an isocyanate group. Such compounds include monoalcohols such as methanol, ethanol, n-propanol, isopropanol, butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols and also hydroxymethylcyclohexane or simple aliphatic or cycloaliphatic monoamines such as methylamine, ethylamine, n-propylamine, isopropylamine, the isomeric butylamines, pentylamines, hexylamines and octylamines, ndodecylamine, n-tetradecylamine, n-hexadecylamine, n-octadecylamine, cyclohexylamine, the isomeric methylcyclohexylamines, and aminomethylcyclohexane, secondary monoamines, such as dimethylamine, diethylamine, dipropylamine, diisopropylamine, dibutylamine, diisobutylamine, bis(2-ethylhexyl)amine, N-methyl- and N-ethyl cyclohexyl amine, and dicyclohexylamine.

These monofunctional compounds D) are employed in amounts of up to 40% by weight, based on the total amount of starting compounds B) and C) which are reactive toward isocyanates.

In accordance with the invention it is also possible to use diisocyanates. These diisocyanates, where used, comprise the abovementioned diisocyanates suitable for preparing the starting compounds A). They may account for up to 60% by weight, based on the overall weight of the starting compounds A) and B). Mixtures suitable for the process of the invention also include, for example, solutions of uretdiones in diisocyanates, such as are obtained following catalytic dimerization and without separation of the unreacted diisocyanate.

In the process of the invention, the polyisocyanates A) containing uretdione groups are reacted, with or without the use of further diisocyanates, with the polymer B) and, where appropriate, C) and also further compounds D) which are monofunctional and reactive toward isocyanates.

For this reaction, appropriate amounts of the starting compounds are metered continuously to an intensive mixer, particularly a single-screw or multiscrew extruder, by means of suitable, commercially customary pumps. The solvent-free synthesis requires temperatures between 110° C. and 190° C. The temperature may be up to 190° C., preferably up to 180° C. and more preferably up to 170° C. These temperatures are already situated well within the cleavage range for uretdiones but without resulting in free isocyanate contents which would lead to uncontrolled reaction events being observed. The short reaction times of <5 minutes, preferably <3 minutes, more preferably <2 minutes, proved advantageous here.

Furthermore, the brief thermal load is sufficient to bring about homogeneous mixing of the reactants and their complete, or very substantial, reaction. A yield of the reaction is preferably at least 90%, more preferably at least 95% and most preferably at least 99%. Subsequently, controlled cooling is carried out in accordance with the establishment of equilibrium, and, where necessary, conversion of the starting materials into the product is completed.

The reaction products are supplied to the intensive mixer in separate product streams. It is possible for the starting components to be preheated up to a maximum of 100° C., preferably up to a maximum of 80° C. Where there are more than two product streams, they may also be metered in, for example, in bundled form. The components B) and C) and also monofunctional compounds D) and catalysts may also be combined into one product stream. Likewise, the sequence of the product streams may be varied, and the entry point for the product streams may be different.

Known techniques and technologies for after-reaction, cooling, size reduction, and bagging are used.

The polyaddition compound containing a uretdione group that is obtainable by the process of the invention represents a valuable starting compound for the preparation of polyurethane polymer by an isocyanate polyaddition process. It finds particular use as a crosslinker component in thermoreactive, transparent or pigmented polyurethane powder coating materials which are free from elimination products.

Having generally described process of the invention for preparing the polyaddition compounds containing uretdione groups, a further understanding can be obtained by reference to certain specific examples which are provided herein for purposes of illustration only, and are not intended to be limiting unless otherwise specified.

### Examples

Preparation of Polyaddition Products Containing an Uretdione Group by the Process According to the Present Invention

General Preparation Procedure

The IPDI uretdione is fed at a temperature of from 60 to 110° C. into the first barrel of an extruder (e.g., twin-screw extruder), and the mixture of the NCO reactive components (e.g., diols, monofunctional alcohols, OH-bearing oligoesters, lactams, etc.), with a temperature of from 25 to 150° C., is metered in at the same time. One of the two streams comprises the catalyst. The extruder used is composed of 10 barrels which are kept at control temperatures by way of 5 heating zones. Zone 1: 60-180° C., zone 2: 60-170° C., zone 3: 60-150° C., zone 4: 80-150° C., zone 5: 60-160° C. All temperatures represent setpoint temperatures. Regulation takes place by way of electrical heating and water cooling, respectively. The die is likewise electrically heated. The screw speed is from 50 to 100 rpm. The throughput is from 10 to 160 kg/h. The reaction product is cooled, fractionated and, where appropriate, ground.

### Example 1

IPDI uretdione (free NCO content 17.7%, latent NCO content 20.1%) was reacted with a mixture of 1,4-butanediol, the diester of 1,4-butanediol and adipic acid (OH number of the mixture: 802 mg KOH/g) and 2-ethylhexanol. As a catalyst, 0.1% of dibutyltin(IV) dilaurate (DBTL) was used. The ratio of NCO groups to OH group was 14 moles to 16 moles, but the molecule was blocked NCO-terminally with 2-ethylhexanol (2 mols of the 16 mols of OH groups, therefore, originate from the 2-ethylhexanol). The chain length was n=7.

In the product, the theoretical free NCO content was 0%. The amount found was 0.23%. The theoretical latent NCO content was 15.1%, the found content 14.7%.

### Example 2 (Comparative)

The starting compounds of Example 1 were reacted in a combination of a static mixer (length 60 mm, D 6 mm, Sulzer SMX-L) and a tube reactor, the tube reactor being composed of three separately jacket-heated segments of capacities 250 ml, 260 ml, 550 ml. The throughput was 6.2 kg/h. The controlled temperature of the mixer was 120° C., the temperature of the tube coil 1 was 140° C., that of the tube coil 2 was 130° C. and that of the tube coil 3 was 120° C. The product exited at a temperature of 155° C. The free NCO content of the product was 1.3% (theory 0%). The latent NCO content was 13.7% (theory 15.1%).

The comparative example shows that the polyaddition product containing uretdione groups that was obtained by the process of the invention described in Example 1 has a much lower free NCO content and a higher latent NCO content. With the product from Example 2, therefore, in contrast to the product from Example 1, a considerable degree of cleavage of the uretdione groups has occurred, with release of isocyanate groups.

### Example 3

IPDI uretdione (free NCO content 17.5%, latent NCO content 20.30) was reacted with a mixture of 1,6-hexanediol, the diester of 1,4-butanediol and adipic acid (OH number of the ester 344 mg KOH/g) and the polycarbonate formed from neopentyl glycol carbonate and 1,4-butanediol (OH number 363 mg KOH/g). As a catalyst, 0.20 of dibutyltin(IV) dilaurate (DBTL) was used.

The ratio of NCO groups to OH groups was 10 moles to 12 moles. In the “OH mixture” the molar ratio of 1,6-hexanediol to the oligoester and polycarbonate was 4 to 1 to 1. The chain length was n=5.

In the product, the theoretical free NCO content was 0%. The amount found was 0.3%. The theoretical latent NCO content was 13.9%, the found content was 13.4%.

### Example 4

IPDI uretdione (free NCO content 17.4%, latent NCO content 20.4%) was reacted with a polycaprolactone (OH number 210 mg KOH/g). As a catalyst, 0.15% of dibutyltin(IV) dilaurate (DBTL) was used.

The ratio of NCO groups to OH groups was 8 moles to 6 moles. The chain length was n=4.

In the product, the theoretical free NCO content was 2.4%. The amount found was 2.6%. The theoretical latent NCO content was 11.0%, the found content was 10.7%.

German patent application 101 185 40.5 filed April 4, 2001, is incorporated herein by reference.

Obviously, numerous modifications and variations on the present invention are possible in light of the above teachings. It is therefore to be understood that within the scope of the appended claims, the invention may be practiced otherwise than as specifically described herein.

1. A process for solventlessly and continuously preparing a polyaddition compound containing an uretdione group, comprising:
reacting in an intensive mixer
A) at least one polyisocyanate containing an uretdione group and having an isocyanate functionality of at least 2.0, and
B) at least one hydroxyl-containing polymer containing at least two hydroxyl groups and at least one further functional group selected from the group consisting of a carboxyl ester group, a carbonate group, an ether group, a thioether group, an ester amide group, an urethane group, an acetal group and a combination thereof;
wherein said hydroxyl-containing polymer has a molecular weight of from 180 to 3500;
wherein said polyaddition compound containing an uretdione group has a melting range of from 40 to 130° C. and contains a) free, partially or totally blocked NCO groups or b) free, partially or totally blocked NCO groups and a terminal hydroxyl group.

2. The process as claimed in claim 1, further comprising reacting C) at least one diol having a molecular weight of from 62 to 400 together with compounds A) and B).

3. The process as claimed in claim 1, further comprising reacting D) at least one monofunctional compound which is reactive toward an isocyanate group together with compounds A) and B).

4. The process as claimed in claim 1, wherein said polyisocyanate A) is obtained from a diisocyanate or a mixture of diisocyanates containing an isocyanate group attached to an aliphatic moiety, a cycloaliphatic moiety, an araliphatic moiety, an aromatic moiety or a combination thereof.

5. The process as claimed in claim 4, wherein said diisocyanate is selected from the group consisting of 1,4-diisocyanatobutane, 1,6-diisocyanatohexane, 2-methylpentamethylene 1,5-diisocyanate, 2,2,4(2,4,4)-trimethylhexamethylene diisocyanate, 4,4′-diisocyanatodicyclohexylmethane, 1,3-diisocyanatocyclohexane, 1,4-diisocyanatocyclohexane, isophorone diisocyanate, norbornane diisocyanate, diphenylmethane-2,4′-diisocyanate, diphenylmethane-4,4′-diisocyanate, xylylene diisocyanate, 2,4-tolylene diisocyanate, 2,6-tolylene diisocyanate and a mixture thereof.

6. The process as claimed in claim 1, wherein said polymer B) is a linear or branched, hydroxyl-containing polyester; a linear or branched, hydroxyl-containing polycaprolactone; a linear or branched, hydroxyl-containing polycarbonate; a linear or branched, hydroxyl-containing polyether; a linear or branched, hydroxyl-containing polythioether; a linear or branched, hydroxyl-containing polyesteramide; a linear or branched, hydroxyl-containing polyurethane or a linear or branched, hydroxyl-containing polyacetal; and
wherein said polymer B) has a number-average molecular weight of from 180 to 3500, a hydroxyl number of between 50 and 900 mg KOH/g, and a functionality of from 2 to 5.

7. The process as claimed in claim 1, wherein said polymer B) is a polyester, a polycaprolactone or a polycarbonate; and
wherein said polymer B) has a number-average molecular weight of from 180 to 3500, a hydroxyl number of between 50 and 900 mg KOH/g, and a functionality of from 2 to 5.

8. The process as claimed in claim 2, wherein said diol C) is selected from the group consisting of ethylene glycol, diethylene glycol, triethylene glycol, 1,2- and 1,3-propanediol, 2-methyl-1,3 propanediol, 2,2-dimethyl-1,3-propanediol, 1,4 butanediol, 1,5-pentanediol, 3-methyl-1,5 pentanediol, 1,6-hexanediol, 2,2,4(2,4,4) trimethylhexanediol, 1,8-octanediol, 1,12-dodecanediol, trans-1,4-cyclohexanedimethanol, cis-1,4-cyclohexanedimethanol, a dimer diol, neopentyl glycol hydroxypivalate and a mixture thereof.

9. The process as claimed in claim 3, wherein said component D) is a monoalcohol, a monoamine or a mixture thereof; and
wherein said component D) is monofunctional and reactive toward an isocyanate group.

10. The process as claimed in claim 9, wherein said monoalcohol is selected from the group consisting of methanol, ethanol, n-propanol, isopropanol, n-butanol, isobutanol, sec-butanol, an isomeric pentanol, an isomeric hexanol, an isomeric octanol, an isomeric nonanol, n-decanol, n-dodecanol, n-tetradecanol, n-hexadecanol, n-octadecanol, cyclohexanol, an isomeric methylcyclohexanol, hydroxymethylcyclohexane and a mixture thereof.

11. The process as claimed in claim 9, wherein said monoamine is selected from the group consisting of methylamine, ethylamine, n-propylamine, isopropylamine, an isomeric butylamine, an isomeric pentylamine, an isomeric hexylamine, an isomeric octylamine, n-dodecylamine, n-tetradecylamine, n-hexadecylamine, n-octadecylamine, cyclohexylamine, an isomeric methylcyclohexylamine, aminomethylcyclohexane, dimethylamine, diethylamine, dipropylamine, diisopropylamine, dibutylamine, diisobutylamine, bis(2-ethylhexyl)amine, N-methyl-cyclohexylamine, N-ethylcyclohexylamine, dicyclohexylamine and a mixture thereof.

12. The process as claimed in claim 1, wherein said reacting takes place in a single-screw or multiscrew extruder.

13. The process as claimed in claim 12, wherein said reacting takes place in a twin-screw extruder.

14. The process as claimed in claim 12, wherein said reacting takes place in a planetary roll extruder.

15. The process as claimed in claim 12, wherein said reacting takes place in an annular extruder.

16. The process as claimed in claim 1, wherein said reacting takes place in an intensive kneading apparatus.

17. The process as claimed in claim 1, wherein a temperature in the intensive mixer is up to 190° C.

18. The process as claimed claim 1, wherein a temperature in the intensive mixer is up to 180° C.

19. The process as claimed in claim 1, wherein a temperature in the intensive mixer is up to 170° C.

20. The process as claimed in claim 1, wherein the intensive mixer effects an intensive mixing of components A) and B) resulting in a viscous product stream with simultaneous intensive heat exchange; and
wherein the intensive mixer effects an uniform flow in the longitudinal direction with a very highly uniform residence time of <5 min.

21. The process as claimed in claim 1, wherein a reactant and a catalyst are supplied to the intensive mixer in separate streams.

22. The process as claimed in claim 1, wherein more than two reactant streams are supplied in bundled form or individually.

23. The process as claimed in claim 2, wherein the components B), C) and D) at least one monofunctional compound which is reactive toward an isocyanate group and/or a catalyst are combined to form one reactant stream.

24. The process as claimed in claim 1, wherein the polyisocyanate A) and a further diisocyanate and/or a catalyst are combined to form one reactant stream.

25. The process as claimed in claim 1, wherein one or more reactant streams comprise a solid.

26. The process as claimed in claim 1, wherein an additive which is inert with respect to the polyisocyanate A) is added to form one reactant stream.

27. The process as claimed in claim 1, wherein reactant streams are not introduced simultaneously and/or are introduced at different entry points of said intensive mixer.

28. The process as claimed in claim 1, further comprising an after-reaction.

29. The process as claimed in claim 1, further comprising cooling of said polyaddition compound to a temperature sufficient for subsequent bagging and/or containerization; and
wherein a preimpression of said polyaddition compound occurs during said cooling.

30. The process as claimed in claim 29, further comprising size reducing of said polyaddition compound.

31. The process as claimed in claim 29, wherein said polyaddition compound is obtained in the form of a strip or film.

32. The process as claimed in claim 30, wherein said size reducing occurs before said cooling.

33. The process as claimed in claim 30, wherein said size reducing occurs after said cooling, thereby reducing a dust fraction.

34. A polyaddition compound containing a uretdione group obtained by the process according to claim 1.

35. A process for preparing a transparent or pigmented polyurethane powder coating material, comprising:
reacting said polyaddition compound containing a uretdione group according to claim 34 in an isocyanate polyaddition process, thereby obtaining said polyurethane powder coating material which is free from an elimination product.
